(19) United States
(12) Patent Application Publication
(10) Pub. No.: US 2008/0003541 A1
(43) Pub. Date: Jan. 3, 2008

(54) Decorative dental overlay

(76) Inventor: Laurel R. Leslie-Martin, Longmont, CO (US)

Correspondence Address: THE OLLILA LAW GROUP LLC, 2060 BROADWAY, SUITE 300, BOULDER, CO, 80302, US

(21) Appl. No.: 11/477,087

(22) Filed: Jun. 28, 2006

(51) Int. Cl. A61C 5/00

(52) U.S. Cl. 433/215

(57) ABSTRACT

A decorative dental overlay is provided according to an embodiment of the invention. The decorative dental overlay includes a plastic overlay portion formed to fit over at least a portion of a set of upper or lower teeth. The plastic overlay portion includes a series of tooth cavities that substantially fit over existing teeth. The decorative dental overlay further includes at least one decorative region formed on the plastic overlay portion.

### BACKGROUND OF THE INVENTION

1. Field of the Invention

The present invention relates to a decorative dental overlay.

2. Statement of the Problem

There are many ways in which people express their individuality. People like to adorn and decorate themselves. They buy jewelry, die their hair, paint their nails, etc.

A cosmetic procedure that people obtain when they have crooked or misaligned teeth is an orthodontic procedure that realigns and repositions individual teeth. New developments in orthodontic technology include clear aligner devices that fit over existing teeth and exert aligning forces on the teeth. A series of such aligner devices are used to gradually move the teeth of a patient.

A retainer is a device that is used to either protect teeth or maintain previously aligned teeth in a desired position. The retainer can be clear or translucent.

An aligner or retainer is typically created by taking an impression of the subject's teeth. The impression is used to cast a mold of the subject's teeth. The mold is then used to form the aligner or retainer. The aligner or retainer can be formed using conventional methods, such as thermoforming. The formed aligner or retainer shell fits substantially over the patient's existing teeth. Subsequently, inward bumps or dimples are formed in the aligner shell. The bumps or dimples exert forces at specific points on the teeth in order to move the teeth. Inward bumps or dimples (i.e., projections that extend towards the teeth) can be placed in the aligner to exert forces at specific points on the teeth in order to move the teeth. As a result, the completed aligner does not fit passively over the existing teeth, but has to be installed with some force.

In the prior art, aligner and retainer devices are employed for mechanical purposes. However, these devices present opportunities to provide individualized aesthetic capabilities.

### SUMMARY OF THE SOLUTION

A decorative dental overlay is provided according to an embodiment of the invention. The decorative dental overlay comprises a plastic overlay portion formed to fit over at least a portion of a set of upper or lower teeth, with the plastic overlay portion comprising a series of tooth cavities that substantially fit over existing teeth, and at least one decorative region formed on the plastic overlay portion.

A decorative dental overlay is provided according to an embodiment of the invention. The decorative dental overlay comprises a plastic overlay portion formed to fit over at least a portion of a set of upper or lower teeth, with the plastic overlay portion comprising a series of tooth cavities that substantially fit over existing teeth, and at least one attachment structure formed on the plastic overlay portion.

A decorative dental overlay is provided according to an embodiment of the invention. The decorative dental overlay comprises a plastic overlay portion formed to fit over at least a portion of a set of upper or lower teeth, with the plastic overlay portion comprising a series of tooth cavities that substantially fit over existing teeth, and at least one decorative object at least partially bonded to the plastic overlay portion.

A decorative dental overlay decorating kit is provided according to an embodiment of the invention. The decorative dental overlay comprises a series of tooth color paints adapted for being applied to a plastic overlay portion of a decorative dental overlay, and a color guide that correlates the series of tooth color paints to a series of natural tooth colors.

A method of forming a decorative dental overlay is provided according to an embodiment of the invention. The method comprises forming a plastic overlay portion to fit over at least a portion of a set of upper or lower teeth, with the plastic overlay portion comprising a series of tooth cavities that substantially fit over existing teeth, and forming at least one decorative region on the plastic overlay portion.

### DESCRIPTION OF THE DRAWINGS

The same reference number represents the same element on all drawings. It should be understood that the drawings are not necessarily to scale.

FIGS. 1-2 show a decorative dental overlay according to an embodiment of the invention.

FIG. 3 shows decorative regions on a front side and a back side of the plastic overlay portion.

FIG. 4 shows the decorative dental overlay wherein the decorative region extends over only a portion of a tooth cavity.

FIG. 5 shows the decorative dental overlay wherein the decorative region extends over multiple tooth cavities.

FIG. 6 shows the decorative dental overlay including multiple decorative regions.

FIG. 7 shows the decorative dental overlay including at least one excised portion according to an embodiment of the invention.

FIG. 8 shows a front view of the decorative dental overlay including a decorative object according to an embodiment of the invention.

FIG. 9 shows a side view of the decorative dental overlay wherein a projection is formed in the plastic overlay portion according to an embodiment of the invention.

FIG. 10 shows a side view of the decorative dental overlay wherein an attachment structure is formed on the plastic overlay portion according to an embodiment of the invention.

FIG. 11 shows the decorative dental overlay including altered tooth shapes and and/or altered tooth sizes.

FIG. 12 shows the decorative dental overlay including an applied film according to an embodiment of the invention.

FIG. 13 shows the decorative dental overlay in use to fill in for a damaged tooth.

FIG. 14 shows a decorative dental overlay decorating kit according to an embodiment of the invention.

### DETAILED DESCRIPTION OF THE INVENTION

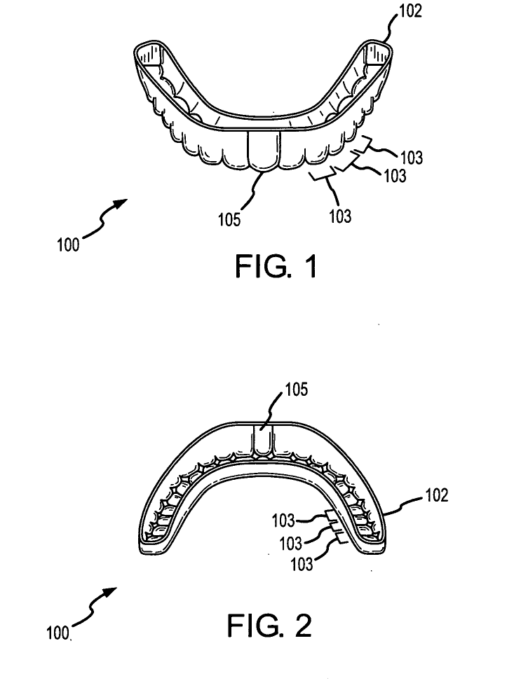

FIGS. 1-14 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIGS. 1-2 show a decorative dental overlay 100 according to an embodiment of the invention. FIG. 1 is a front (labial) view of the decorative dental overlay 100 and FIG. 2 is a rear (lingual) view. The decorative dental overlay 100 includes a plastic overlay portion 102 that is formed to substantially fit over at least a portion of a set of upper or lower teeth. As a result, very minimal force is required to place the plastic overlay portion 102 on the wearer's teeth. The decorative dental overlay 100 further includes at least one decorative region 105 formed on the plastic overlay portion 102. When the decorative dental overlay 100 is worn by a person, the decorative region 105 is visible on the person's teeth.

The plastic overlay portion 102 comprises a series of tooth cavities 103. The tooth cavities 103 can fit over any number of teeth. The plastic overlay portion 102 does not have to include all of the upper or lower teeth of the wearer. A decorative region 105 according to the invention can span part of a tooth cavity 103 or can span any number of tooth cavities 103.

The plastic overlay portion 102 can be thermoformed, for example. The plastic overlay portion 102 can be substantially rigid or can be at least partially flexible. The plastic overlay portion 102 can comprise a polymer material, for example.

The decorative region 105 can be formed to appear on the outer surfaces of the wearer's teeth. In one embodiment, a decorative region 105 is formed on an inside portion of one or more tooth cavities 103. Consequently, the decorative region 105 is protected when the decorative dental overlay 100 is being worn. Alternatively, the decorative region 105 can be formed on an outside of the plastic overlay portion 102.

The decorative region 105 can be formed at a tooth cavity 103 that receives a tooth. The decorative region 105 therefore can alter the tooth appearance, such as by changing a tooth color or obscuring the tooth. In some cases, the decorative region 105 can act as a stain or veneer and can provide a more natural or pleasing tooth color and appearance.

Alternatively, the decorative region 105 can be formed at a tooth cavity 103 that does not receive a tooth. In addition, the decorative region 105 can be formed at a tooth cavity 103 that is only partially filled by a tooth, such as an undersized or damaged tooth (see FIG. 13). This is referred to in the dental field as a pontic, where a pontic is a replacement or artificial tooth or teeth.

A pontic in the prior art is mounted on a fixed or removal dental appliance. Pontics are used in both partial and complete dentures. However, a prior art pontic takes significant time to produce. A prior art pontic is expensive. A prior art pontic typically must be attached to adjacent teeth or fixed to an implant installed in the bone.

A pontic can be formed in the decorative dental overlay 100 according to the invention. A desired tooth cavity or cavities is first formed in the plastic overlay portion 102, such as by adding a pontic to the mold and forming the plastic overlay portion 102 on the mold. The mold is made from an impression of the person's teeth and the plastic overlay portion 102 is formed over the mold. The pontic on the mold creates a tooth cavity in the plastic overlay portion 102. The created tooth cavity is then painted.

The decorative region 105 can comprise a painted region. The painted region can include a sealer that protects the underlying paint. The paint can comprise natural tooth color paint. For example, the paint can mask a missing, damaged, or discolored tooth, as previously described. In addition, the paint can comprise other non-tooth color paints, including decorative colors. The colors can include any manner of designs, symbols, characters or alphanumeric characters, etc. The decorative region 105 can have a metallic appearance. The decorative region 105 can comprise designs, symbols, graphics, etc.

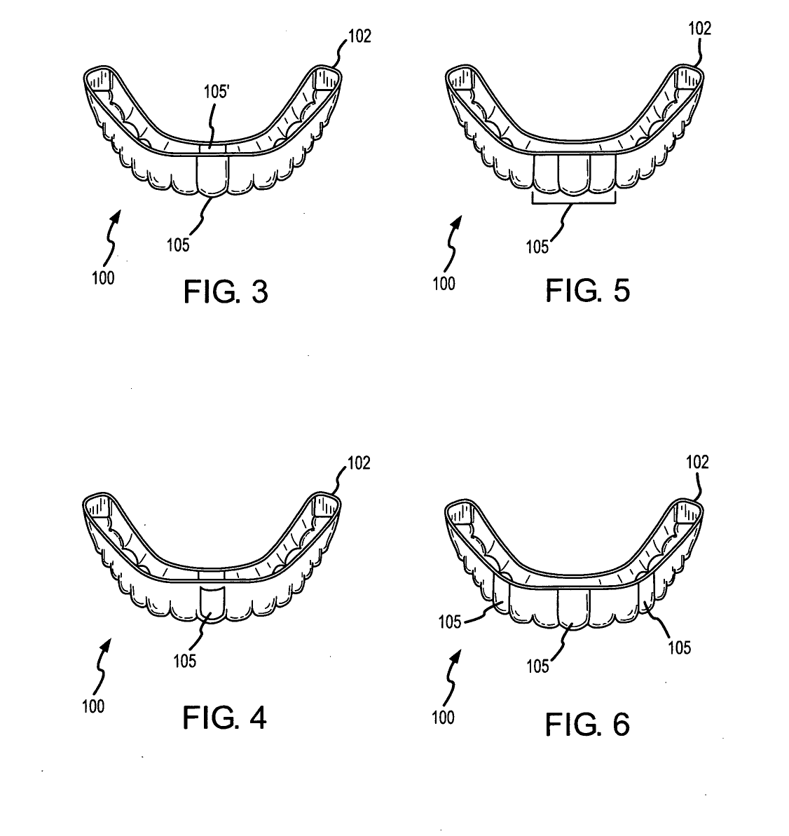

FIG. 3 shows decorative regions 105 and 105′ on the front side and the back side of the plastic overlay portion 102. Although only the front decorative region 105 is necessary in most cases for an acceptable appearance, it should be understood that alternatively both the front and back of the plastic overlay portion 102 can include decorative regions 105 and 105′.

FIG. 4 shows the decorative dental overlay 100 wherein the decorative region 105 extends over only a portion of a tooth cavity 103. The size and extent of the decorative region 105 can be varied as desired.

FIG. 5 shows the decorative dental overlay 100 wherein the decorative region 105 extends over multiple tooth cavities 103. The decorative region 105 can be substantially continuous, as shown, or can be discontinuous.

FIG. 6 shows the decorative dental overlay 100 including multiple decorative regions 105. In this embodiment, the various decorative regions 105 do not have to be adjacent.

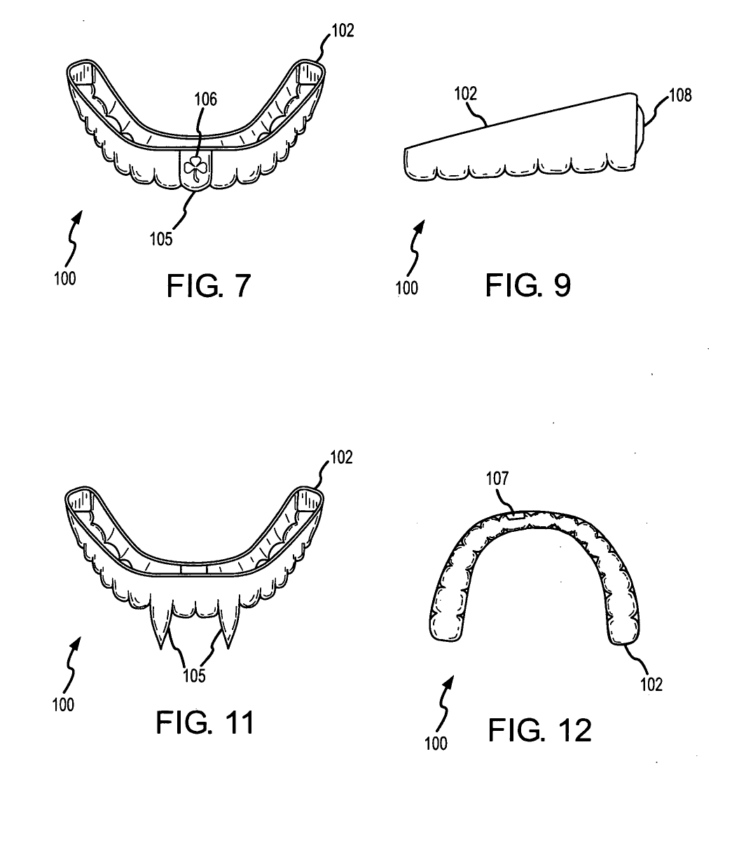

FIG. 7 shows the decorative dental overlay 100 including at least one excised portion 106 according to an embodiment of the invention. The excised portion 106 can be cut, punched, stamped, or otherwise removed from the plastic overlay portion 102. In some embodiments, the excised portion 106 is removed from a decorative region 105. The confluence of an excised portion 106 and a decorative region 105 may create a desired effect, including a heightened visual contrast.

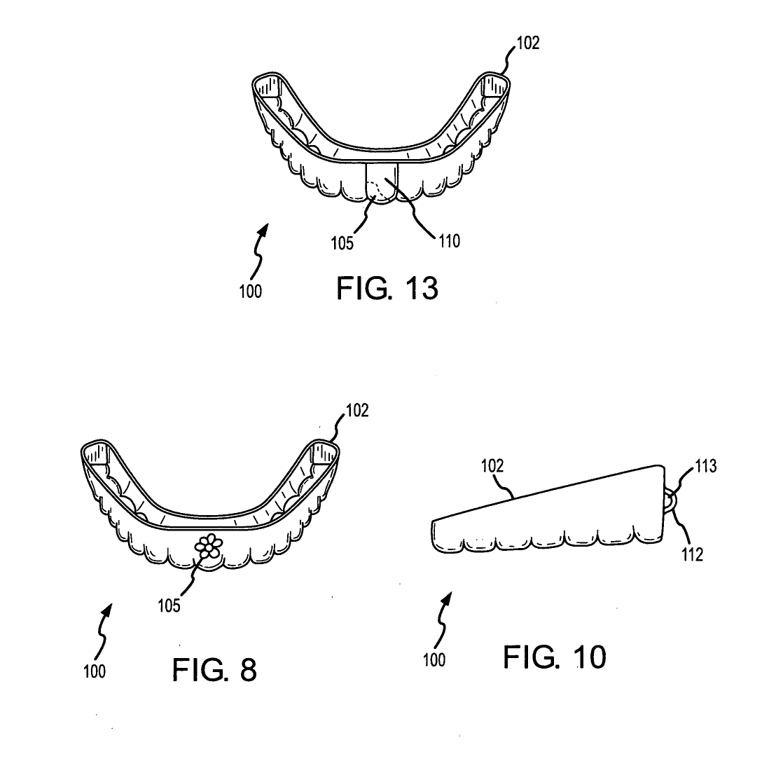

FIG. 8 shows a front view of the decorative dental overlay 100 including a decorative object 105 according to an embodiment of the invention. The decorative object 105 can comprise any shape, item, etc. For example, the decorative object 105 can comprise a symbol, gem, or charm, among other things. It should be understood that the decorative dental overlay 100 can include multiple decorative objects 105 as desired.

The decorative object 105 can be received and held in a projection formed in the plastic overlay portion 102 (see the text below accompanying FIG. 9). Alternatively, the decorative object 105 can be at least partially bonded to the plastic overlay portion 102. For example, where the plastic overlay portion 102 is thermoformed, the plastic overlay portion 102 may bond to the decorative object 105 during the forming process. The decorative object 105 can be placed on the tooth mold and can be formed over by (and adhered to) the plastic overlay portion 102 during the forming process. A sealer can be used to cover and protect the decorative object 105.

FIG. 9 shows a side view of the decorative dental overlay 100 wherein a projection 108 is formed in the plastic overlay portion 102 according to an embodiment of the invention. The projection 108 extends outwardly from the plastic overlay portion 102, as shown. The projection 108 can receive paint, paint and sealer, decorative objects (such as gems or charms), etc., and therefore can include the decorative region 105. The projection 108 can make painting the decorative region 105 easier and more accurate. It should be understood that the decorative dental overlay 100 can include multiple projections 108 as desired.

FIG. 10 shows a side view of the decorative dental overlay 100 wherein an attachment structure 112 is formed on the plastic overlay portion 102 according to an embodiment of the invention. The attachment structure 112 extends outwardly from the plastic overlay portion 102. The attachment structure 112 can include an aperture 113. Various decorative items can be affixed to the attachment structure 112, such as charms, jewelry, etc. The attachment structure 112 can include a locking fixture, loop, eyelet, etc., that is attached to or formed to the plastic overlay portion 102.

The attachment structure 112 can be formed from the material of the plastic overlay portion 102 or can comprise an independent component that is bonded, welded, or otherwise affixed to the plastic overlay portion 102. It should be understood that the decorative dental overlay 100 can include multiple attachment structures 112 as desired.

FIG. 11 shows the decorative dental overlay 100 including altered tooth shapes and/or altered tooth sizes. The tooth shape and/or size can be altered by altering a mold made from a tooth impression of the person. Material can be added to or removed from the mold before the mold is used, to form the plastic overlay portion 102. The mold is altered prior to forming the overlay. As a result, a tooth can be altered or repaired, and the plastic overlay portion 102 plus the decorative region 105 provides a repaired or unblemished appearance for the wearer.

In this embodiment, a tooth cavity 103 in the plastic overlay portion 102 deviates from a normal or expected tooth shape. For example, the tooth cavity 103 can be larger than a corresponding tooth of a subject. The application of the decorative region 105 can cause the decorative dental overlay 100 to represent a larger tooth or a tooth of a different shape, such as where a tooth is broken, chipped, severely worm, or otherwise damaged. Consequently, the decorative dental overlay 100 can be used to alter a tooth shape and/or alter a tooth size.

FIG. 12 shows the decorative dental overlay 100 including an applied film 107 according to an embodiment of the invention. The applied film 107 in this embodiment comprises a decorative region 105. The applied film 107 can be at least partially bonded to the plastic overlay portion 102. In some embodiments, an applied film 107 can be applied to the mold, wherein the applied film 107 is subsequently bonded to the inside of the plastic overlay portion 102 when the plastic overlay portion 102 is formed over the mold. The bonding can comprise an adhesive or other bonding agent, a melt or weld, an electrostatic attraction, etc. It should be understood that the decorative dental overlay 100 can include multiple applied films 107 as desired. The applied film 107 can be on the outside or the inside of the plastic overlay portion 102. A sealer can optionally be applied over the applied film 107.

The applied film 107 can comprise an applique, decal, etc. For example, the applied film 107 can comprise a decorative film designed for use with a toenail or fingernail.

FIG. 13 shows the decorative dental overlay 100 in use to fill in for a damaged tooth 110. The configuration of the tooth can be repaired by first altering a mold made from a tooth impression of the person. The altered mold is then used to form the overlay, presenting the appearance of an unblemished tooth in place of the damaged tooth. The damaged tooth 110 can be chipped, broken, cracked, ground or worn off, etc. A corresponding tooth cavity 103 includes a decorative region 105, such as a decorative region created to match adjacent teeth of the person. By wearing the decorative dental overlay 100, the damaged tooth 110 can be made to look substantially normal in appearance.

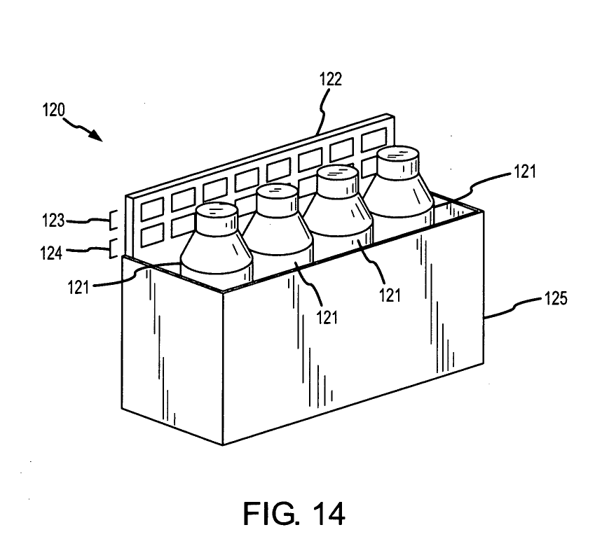

FIG. 14 shows a decorative dental overlay decorating kit 120 according to an embodiment of the invention. The decorative dental overlay decorating kit 120 can accompany a decorative dental overlay 100, for example. The decorative dental overlay decorating kit 120 includes a series of tooth color paints 121 adapted for being applied to the plastic overlay portion 102 of the decorative dental overlay 100. The series of tooth color paints 121 can be arranged in a carrier 125. The decorative dental overlay decorating kit 120 further includes a color guide 122. The color guide 122 correlates the series of tooth color paints 121 to a series of natural tooth colors. Consequently, the color guide 122 can include a series of natural tooth color samples 123 and a corresponding series of paint identifiers 124. The series of paint identifiers 124 can specify a paint of the series of tooth color paints 121 that will generate the tooth color. In addition, the series of paint identifiers 124 can specify a combination/mix of paints that will generate the tooth color. As a result, the color guide 122 can be used to select a tooth color paint (or paints) for a particular subject.

In addition, the decorative dental overlay decorating kit 120 can include a series of non-tooth color paints 121. Further, the kit 120 can include a sealer 121 that can be applied over a painted region in order to seal and protect the underlying paint.

A method of forming a decorative dental overlay 100 according to the invention comprises forming a plastic overlay portion 102 to fit over at least a portion of a set of upper or lower teeth, with the plastic overlay portion 102 comprising a series of tooth cavities 103, and forming at least one decorative region 105 on the plastic overlay portion 102.

1. A decorative dental overlay, comprising:
a plastic overlay portion formed to fit over at least a portion of a set of upper or lower teeth, with the plastic overlay portion comprising a series of tooth cavities that substantially fit over existing teeth; and
at least one decorative region formed on the plastic overlay portion.

2. The decorative dental overlay of claim 1, with the decorative region including a tooth cavity that does not receive a tooth.

3. The decorative dental overlay of claim 1, with the decorative region including a tooth cavity that receives a tooth.

4. The decorative dental overlay of claim 1, further comprising a sealer applied over the at least one decorative region.

5. The decorative dental overlay of claim 1, with the decorative region comprising one or more painted regions.

6. The decorative dental overlay of claim 5, with a painted region of the one or more painted regions comprising a tooth color paint.

7. The decorative dental overlay of claim 5, with a painted region of the one or more painted regions comprising a non-tooth color paint.

8. The decorative dental overlay of claim 1, with the decorative region comprising one or more painted regions covered with a sealer.

9. The decorative dental overlay of claim 1, with the decorative region comprising one or more painted projections formed in the plastic overlay portion.

10. The decorative dental overlay of claim 1, with the decorative region comprising at least one excised portion.

11. The decorative dental overlay of claim 1, with the decorative region comprising one or more applied films.

12. The decorative dental overlay of claim 1, with the decorative region comprising at least one decorative object.

13. The decorative dental overlay of claim 1, with the decorative region comprising at least one decorative object at least partially bonded to the plastic overlay portion.

14. The decorative dental overlay of claim 1, with the decorative region comprising at least one attachment structure formed on the plastic overlay portion.

15. The decorative dental overlay of claim 1, with the decorative region altering one or more of a tooth shape or a tooth size.

16. A decorative dental overlay, comprising:
a plastic overlay portion formed to fit over at least a portion of a set of upper or lower teeth, with the plastic overlay portion comprising a series of tooth cavities that substantially fit over existing teeth; and
at least one attachment structure formed on the plastic overlay portion.

17. The decorative dental overlay of claim 16, with the at least one attachment structure comprising a decorative object.

18. The decorative dental overlay of claim 16, with the at least one attachment structure being at least partially bonded to the plastic overlay portion.

19. A decorative dental overlay, comprising:
a plastic overlay portion formed to fit over at least a portion of a set of upper or lower teeth, with the plastic overlay portion comprising a series of tooth cavities that substantially fit over existing teeth; and
at least one decorative object at least partially bonded to the plastic overlay portion.

20. The decorative dental overlay of claim 19, with the decorative object including a tooth cavity that does not receive a tooth.

21. The decorative dental overlay of claim 19, with the decorative object including a tooth cavity that receives a tooth.

22. The decorative dental overlay of claim 19, with the decorative object comprising at least one attachment structure formed on the plastic overlay portion.

23. A decorative dental overlay decorating kit, comprising:
a series of tooth color paints adapted for being applied to a plastic overlay portion of a decorative dental overlay; and
a color guide that correlates the series of tooth color paints to a series of natural tooth colors.

24. The decorative dental overlay decorating kit of claim 23, further comprising a series of non-tooth color paints for applying to the plastic overlay portion.

25. A method of forming a decorative dental overlay, the method comprising:
forming a plastic overlay portion to fit over at least a portion of a set of upper or lower teeth, with the plastic overlay portion comprising a series of tooth cavities that substantially fit over existing teeth; and
forming at least one decorative region on the plastic overlay portion.

26. The method of claim 25, with the decorative region including a tooth cavity that does not receive a tooth.

27. The method of claim 25, with the decorative region including a tooth cavity that receives a tooth.

28. The method of claim 25, further comprising applying a sealer over the at least one decorative region.

29. The method of claim 25, with the decorative region comprising one or more painted regions.

30. The method of claim 29, with a painted region of the one or more painted regions comprising a tooth color paint.

31. The method of claim 29, with a painted region of the one or more painted regions comprising a non-tooth color paint.

32. The method of claim 25, with the decorative region comprising one or more painted regions covered with a sealer.

33. The method of claim 25, with the decorative region comprising one or more painted projections formed in the plastic overlay portion.

34. The method of claim 25, with the decorative region comprising at least one excised portion.

35. The method of claim 25, with the decorative region comprising one or more applied films.

36. The method of claim 25, with the decorative region comprising at least one decorative object.

37. The method of claim 25, with the decorative region comprising at least one decorative object at least partially bonded to the plastic overlay portion.

38. The method of claim 25, with the decorative region comprising at least one attachment structure formed on the plastic overlay portion.

39. The method of claim 25, with the decorative region altering one or more of a tooth shape or a tooth size.

40. The method of claim 25, with the forming further comprising thermoforming.
